(19) United States
(12) Patent Application Publication
(10) Pub. No.: US 2022/0285762 A1
(43) Pub. Date: Sep. 8, 2022

(54) METHOD FOR COOLING A BATTERY AND COOLING SYSTEM

(71) Applicant: Volocopter GmbH, Bruchsal (DE)

(72) Inventor: Nils ZIEGLER, Bretten (DE)

(73) Assignee: Volocopter GmbH, Bruchsal (DE)

(21) Appl. No.: 17/687,767

(22) Filed: Mar. 7, 2022

(30) Foreign Application Priority Data
Mar. 5, 2021 (DE) 102021105378.1

(51) Int. Cl. H01M 10/6568; H01M 10/44; H01M 10/613; H01M 10/643; H01M 10/6554; H01M 10/6556; H02J 7/00

(52) U.S. Cl. CPC H01M 10/6568; H01M 10/44; H01M 10/613; H01M 10/643; H01M 10/6554; H01M 10/6556; H02J 7/0068

(57) ABSTRACT

A method for cooling a battery for an electrically powered aircraft, wherein the battery has battery cell(s) and a battery cooling device with a latent heat store. The method includes: A) transferring a first amount of heat from the battery cell to the latent heat store, causing a phase transition in the phase change material, B) removing the battery from the aircraft, C) establishing an operative connection of the battery cooling device to a cooling circuit of a separate second cooling device, D) passing a flow of a coolant through the cooling circuit, E) transferring a second amount of heat from the latent heat store to the coolant, thus causing a phase transition to occur in the phase change material, and F) disconnecting the battery cooling device from the cooling circuit. Step E and/or F are carried out at least partially simultaneously with a charging process of the battery.

### INCORPORATION BY REFERENCE

The following documents are incorporated herein by reference as if fully set forth: German Patent Application No.: 10 2021 105 378.1, filed Mar. 5, 2021.

### TECHNICAL FIELD

The invention relates to a method for cooling a battery for an electrically powered aircraft. The invention further relates to a cooling system for cooling at least one battery cell of an electrically operated aircraft.

### BACKGROUND

The power supply of electrically or partially electrically (hybrid) powered aircraft is usually provided by batteries. Secondary batteries, i.e. rechargeable batteries, are generally used for this purpose and are replaced regularly.

For example, DE 10 2012 202 698 A1 discloses an electrically powered aircraft comprising at least one battery cell and a plurality of electric drive units. The battery cell is used to store and deliver electrical energy required to operate the electrical drive units of the aircraft.

During flight operation, the battery cell discharges in an electrical discharge process. The discharging process can also begin already before flight operation, for example if electrical energy is required for on-board electronics or auxiliary units of the aircraft.

In the event of a discharged battery, the discharged battery cell must be recharged in an electrical charging process before the aircraft can resume its further operation. In contrast to the discharging process, the charging process usually takes place when the aircraft is in an idle state. In this process, the battery cell is connected to a voltage source, which restores the state of charge of the battery cell. Consequently, the term ‘battery cell’ extends to rechargeable electric accumulators. In the following, the terms battery, battery cell and accumulators are used interchangeably.

Both the discharging process and the charging process of the battery cell take place via chemical reactions in the battery cell. These reactions are accompanied by heat generation in the battery cell. Basically, this heat generation is dependent on the discharge rate and the charge rate of the battery cell, i.e. the amount of electrical power delivered or absorbed by it.

The heat generated during the discharging and charging process can be dissipated by means of a battery cooling device.

Battery cooling devices with air cooling are known from the prior art. For this purpose, a plurality of lithium-ion round cells are arranged at large distances from one another. This creates gaps between the lithium-ion round cells, in which gaps an airflow can flow and/or circulate. This airflow ensures convective heat dissipation via the surfaces of the battery cells. The disadvantage here is that large distances between the battery cells are accompanied by the need for a correspondingly large installation space. Another disadvantage of air-cooled battery cells is that the more fire protection material is placed around the cells, the more ineffective the cooling. If the fire protection material is omitted, the safety level of the battery drops.

Battery cooling devices with cooling plates through which liquid cooling media flow are also known. Such a cooling plate can be in thermal contact with a battery cell to be cooled and can be connected to a cooling circuit. By appropriately dimensioning the cooling capacity of the cooling circuit, a high amount of heat can be dissipated in a short time. If the cooling capacity is high, the surface area required for thermal contact between the battery cell and the battery cooling device can also be dimensioned to be small. The cooling plate can be arranged to the side of, above or below one or more battery cells. The disadvantage of such a battery cooling device is that many of the cooling media used are flammable and environmentally harmful, and the cooling device has a high weight that must be carried in the aircraft.

Latent heat accumulators, as described in the document US 2015/0037647 A1, are another possibility known from the prior art for dissipating heat from a battery cell. In contrast to conventional materials, these have a constant phase transition temperature. This means that heat can be added to or removed from the latent heat store in a certain temperature range during the change in its aggregate state without its temperature changing. Instead, the absorption of heat causes a phase transformation of the phase change material (PCM) of the latent heat store, for example from solid to liquid/viscous.

Thus, when latent heat stores are used to cool battery cells in aircraft, the temperature of the battery cell or battery cooling device does not change significantly, but the described phase transition of the latent heat store, usually from solid to liquid/viscous, takes place basically in the form of an isothermal change of state. Since the batteries for electrically powered aircraft, as described above, are usually rechargeable accumulators, the phase transition of the latent heat store must be reversed before the battery or the battery cooling device can be operated further or next, in order to be able to achieve a good cooling effect again. This reversal of the phase transition of the phase change material of the latent heat store is generally carried out by cooling the latent heat store.

In the following, the terms phase change material and latent heat store are used interchangeably.

### SUMMARY

The object of the invention is therefore to overcome the disadvantages of methods for cooling batteries that exist in the prior art. In particular, the cooling of rechargeable batteries is to be made possible.

This object is achieved by a method for cooling a battery having one or more of the features disclosed herein. Advantageous embodiments of the method are found below and in the claims. Further, the object is achieved by a cooling system having one or more of the features disclosed herein. Advantageous embodiments of the cooling system are also found below and in the claims To avoid repetition, the claims are hereby explicitly incorporated by reference in the description.

The method according to the invention for cooling a battery for an electrically powered aircraft is carried out using a battery cooling device with a latent heat store. The battery has at least one battery cell. The method comprises the following method steps:

A transferring a first amount of heat from the battery cell to the latent heat store, thus causing a phase transition to occur in the phase change material of the latent heat store,

B removing the battery from the aircraft,

C establishing an operative connection of the battery cooling device to a cooling circuit of a separate second cooling device,

D passing a flow of a coolant through the cooling circuit,

E transferring a second amount of heat from the latent heat store to the coolant, thus causing a phase transition to occur in the phase change material of the latent heat store, and

F disconnecting the battery cooling device from the cooling circuit.

It is essential that method step D and/or method step E take place at least partially simultaneously with a charging process of the battery.

The object according to the invention is further achieved by a cooling system for cooling at least one battery cell of an electrically operated aircraft. The cooling system comprises, as known per se, a battery cooling device designed to absorb a first amount of heat at least from the battery cell during an electrical discharge process of the battery cell. The battery cooling device is formed with at least one latent heat store having a variable aggregate state.

Essentially, the cooling system comprises a separate second cooling device which is thermally coupleable to the battery cooling device and is designed to receive a second amount of heat from the battery cooling device. Further, the cooling system comprises an electrical charging device for the battery cell for electrically contacting and charging the battery cells for the charging process of the battery cell.

The invention is based on the finding by the applicant that a combination of a first battery cooling device arranged on the battery cell with a latent heat store and a second external cooling device for cooling the latent heat store results in a comparatively light and safe cooling system. The cooling of the battery cell by the battery cooling device and the cooling of the latent heat store thus take place with a time delay if the two cooling devices are connected to each other via a thermal interface.

The separate second cooling device is designed to remove heat from the latent heat store of the battery cooling device and thereby reverse the phase transition of the latent heat store (hereinafter also referred to as reversal reaction or restoration of the functionality of the battery cooling device). In addition to the latent heat store, the complete battery with all components can also be cooled back to a predefined starting temperature to ensure the same starting temperature of the entire battery every time the aircraft is started.

At the same time, during the reversal reaction in the latent heat store, the battery can be charged for the next use.

This results in particular in the following advantages: The discharging process of the at least one battery cell of the aircraft takes place primarily during flight operation. Heat is generated in the process. This first amount of heat is dissipated approximately isothermally to the phase change material of the latent heat store of the battery cooling device. This results in a phase transition in the phase change material of the latent heat store. If the phase change material of the latent heat store is, for example, a composite material, the resulting heat capacity is an average value of the materials present. As a result, the temperature in this area increases slightly and no pure isothermal change of state of the latent heat store occurs.

During flight operation, the heat can thus be dissipated with a cooling system that is comparatively lightweight.

Preferably, the latent heat store comprises materials such as paraffin compounds or ester compounds, which can most preferably be incorporated in a polymer matrix. These materials each have a comparatively low density with a simultaneously high amount of latent heat. This first amount of heat is variable and does not necessarily correspond to the heating of the battery by the discharge process, since part of this heat can also be dissipated as sensible heat to components of the battery.

In the idle state, i.e. usually after flight operation, the battery cooling device is removed from the aircraft and contacted via a thermal interface with a cooling circuit of the separate second cooling device. This is a purely thermal interface. Thus, the phase change material of the latent heat store of the battery cooling device is in thermal contact with the second cooling device, but there is no exchange of cooling fluids or the like. The cooling fluid merely flows through the second cooling device. The heat-conducting connection between the latent heat store and the second cooling device dissipates both the first amount of heat stored in the latent heat store and, if necessary, further heat generated, for example, by the charging process of the battery.

The reversal reaction of the latent heat store and the charging process of the battery thus take place at least partially simultaneously. For charging, the battery cell is connected to a voltage source, as is known per se. Preferably, after method step B, the battery is inserted into a holder of a ground charging station, which allows simultaneous charging of the battery and cooling of the latent heat store. Preferably, the charging of the battery and the restoration of the battery cooling device to functionality occurs when the battery is replaced, usually when the aircraft is stopped.

Due to the separation of the battery cooling device in the aircraft on the one hand and the reversal reaction of the latent heat store by the second cooling device during the charging process on the other hand, advantageously no heavy aggregates are required in flight operation, i.e. on board the aircraft, in order to be able to operate the battery cooling device. In particular, heavy and complex parts such as compressor, pump, valves, heat exchanger, etc. are located outside the aircraft. On the one hand, this results in the advantage that these components do not have to be certified for transport and/or use on board an aircraft. On the other hand, these components, which usually have a high weight, do not have to be transported on board the aircraft. Therefore, particularly large and powerful components can be used which would not be practical or suitable for use on board the aircraft due to their weight.

In a preferred embodiment of the invention, method step D occurs after method step C, that is to say, the coolant is not permanently located in the second cooling device. Rather, the coolant for the reverse reaction for restoring the functionality of the battery cooling device is only pumped into the cooling circuit, which is operatively connected to the latent heat store, when this operative connection has been established. This has the advantage that the inflow of the coolant in method step D causes the cooling hoses to expand and press against a housing of the battery.

Preferably, the cooling circuit operates according to the counterflow heat exchanger principle. This has the advantage that the temperature distribution of the battery cells is as homogeneous as possible. This is particularly advantageous for the simultaneous charging process of the battery cells.

Alternatively, the cooling circuit is designed as a DC heat exchanger. This has the advantage that the cooling circuit can be realized with a simpler structure.

In a preferred embodiment of the invention, after method step B, i.e., after removal of the battery from the aircraft, the battery is inserted into a holder of a ground charging station that allows simultaneous charging of the battery and cooling of the latent heat store of the battery cooling device. Preferably, the second cooling device is part of a stationary ground charging station. The ground charging station comprises an electrical charging device for the battery cells and is designed to electrically contact the battery cells for the charging process.

Preferably, a plurality of batteries of an aircraft are inserted on rails into a holding device. Between the batteries there are cooling hoses that are connected to an external cooling circuit in the ground charging station. During the insertion process, there is preferably not yet any cooling medium in the cooling hoses. Only after the batteries have been positioned in the holding device is the cooling medium pumped into the cooling hoses, so that the cooling hoses expand and press against the housings of the batteries. This has the advantage of improving the operative connection between the battery cooling device and the cooling circuit. Another advantage of this design is that the flexible cooling hose compensates for manufacturing tolerances without the need to use so-called “gap fillers”, as is usually the case, to establish good thermal contact, which significantly improves heat transfer.

Preferably, the second cooling device has at least two cooling hoses and is designed such that a flow passes through the two cooling hoses according to the counterflow principle. Alternatively, one cooling hose with two connections can also be provided, through which a flow is passed according to the counterflow principle.

Preferably, the phase change material of the latent heat store is designed for a temperature range for heat generation of the battery cell in an operating state, in particular in the range of 20 to 60° C., preferably in the range of 43 to 50° C.

A further advantage of the invention is that the respective cooling capacities of the battery cooling device and the second cooling device can be dimensioned largely independently of one another. In particular, the first amount of heat is not in a fixed ratio to the second amount of heat. This is due, among other things, to the fact that the latent heat store of the battery cooling device can radiate or convectively dissipate part of the stored first amount of heat to its surroundings between or during the discharging process and the charging process. Furthermore, additional heat can be generated in the battery cell during the charging process, especially in the case of a fast charging process, which must also be dissipated, preferably via the second cooling device.

Advantageously, the second cooling device is designed in such a way that the second amount of heat that can be dissipated allows a complete reversal reaction of the phase transition of the latent heat store of the battery cooling device to restore the functionality of the battery cooling device and, in addition, heat generated during the charging process can be dissipated.

Preferably, the second cooling device has a flexible hose through which the coolant can flow. Contact pressure and heat transfer by thermal contact are directly related here - the higher the contact pressure, the higher the thermal contact resistance and thus the transferred heat. The flexibility of the hose can therefore be used to set the contact pressure directly via the pressure of the cooling medium. If the flexible hose is filled with a coolant that is under pressure, the hose expands. This increases the contact pressure so that the amount of heat that can be dissipated increases.

Preferably, the battery has a base plate to which electrical insulation in the form of a film, preferably a Kapton film, is adhesively bonded on the side of the battery cells. The negative terminals of the battery cells are adhesively bonded to the electrical insulation of the base plate with a thermally conductive adhesive or a thermally conductive resin. The outside of the base plate is in direct contact with the second cooling device in the form of a cooling hose. The adhesive (resin or glue), the electrical insulation film, and the base plate form a thermal interface between the negative terminals of the battery cells and the second cooling device. Through this thermal interface, both the battery cells and the material of the latent heat store in contact with the battery cells are cooled down. The design of the base plate as an electrically insulating layer prevents a short circuit between the battery cells.

Preferably, the base plate is made of the carbon fiber material T700s.

In a preferred embodiment of the invention, the phase change material of the latent heat store of the battery cooling device is macroencapsulated in a carrier matrix. If materials such as paraffin compounds or ester compounds are used as the phase change material, the latent heat store loses its shape due to the phase transition, and the phase change material melts. Encapsulation in the carrier matrix ensures the dimensional stability of the latent heat store.

Preferably, the phase change material of the latent heat store of the battery cooling device is formed as a sleeve around the battery cells. The design and arrangement of the phase change material in the form of sleeves around the individual battery cells has the advantage that a larger contact area between the battery cell and the phase change material can be used for heat transfer. Furthermore, a more uniform temperature distribution is achieved in the individual cells. This increases the service life of the battery cells. Alternatively, the phase change material is in the form of a plate as an at least partial housing around a plurality of battery cells or is in the form of at least one perforated plate. This may have advantages for the production and assembly of the battery.

In a preferred embodiment of the invention, the second cooling device is part of a stationary ground charging station. The ground charging station has an electrical charging device for the battery cells and is designed to electrically contact the battery cells for the charging process of the battery cells. This has the advantage that during a landing or intermediate landing of the aircraft, the batteries can be exchanged in a simple manner and replaced by new charged batteries with a restored battery cooling device. For this purpose, the ground charging station preferably comprises a holder for the batteries, which is designed to connect the second cooling device and the battery cooling device in a thermally conductive manner.

Advantageously, all negative terminals of the battery cells point in the same direction. The reason for this arrangement is the much larger surface area of the negative cell terminals compared with the positive cell terminals, which enable much more effective heat transfer. Another reason is that, in case of a thermal runaway of the battery cell, the described arrangement allows the hot and toxic venting gases to be conducted through the CID valves located on the positive cell terminal side into a system through which the gases can be conducted out of the batteries.

In this arrangement, the battery cells are preferably connected using the wire bonding method in that the battery comprises a busbar and the battery cells are electrically conductively connected to the busbar via at least one wire bond. For this purpose, the battery cells are oriented in the same way, but they are connected in parallel and in series with one another. In the usual wire bonding processes, both connections are placed on one side of the battery cell, for example, the housing ring with the negative terminal is located directly next to the positive terminal cap. The electrical connection for both terminals can thus be provided on one side of the battery cells, preferably on the side of the positive terminals. Preferably, thermal contact is provided on the opposite, negative side, since the contact area of the negative terminals is larger.

Round cells have a high mechanical bending stiffness. The same geometric orientation of the battery cells can therefore increase the overall stiffness of the battery and reduces the risk of battery damage.

In a preferred embodiment of the invention, the battery comprises a fire protection material that at least partially encloses the battery cells.

Preferably, the phase change material of the latent heat store is surrounded by or integrated into a fire protection material and the fire protection material is at least two-layered. A first layer of the fire protection material is mechanically stable and a second layer of the fire protection material comprises hydrated material.

In the event of a thermal runaway of the battery cells, the high temperatures generated during a thermal runaway are absorbed by the hydrated material of the second layer of the fire protection material. The material undergoes a phase change and can thus absorb at least part of the thermally released energy at a constant temperature.

Furthermore, the first layer of the fire protection material, which is mechanically stable, prevents the battery cell from bursting. This protects adjacent battery cells from both critical temperatures and mechanical damage caused by metal splinters or the like. The adjacent battery cells thus do not themselves enter a critical temperature range, which would also lead to a thermal runaway of the adjacent battery cells.

The invention is particularly suitable for use in safety-critical areas such as manned and unmanned aviation. Further details on possible applications are described in the applications “Battery cooling device with fire protection material, battery module with fire protection material as well as aircraft” and “Battery cooling device, battery module as well as aircraft” with an application date of March 5, 2021 in the name of the applicant.

### BRIEF DESCRIPTION OF THE DRAWINGS

Further preferred features and embodiments of the method according to the invention and of the cooling system according to the invention are explained below with reference to exemplary embodiments and the figures. These exemplary embodiments as well as any dimensions indicated are merely advantageous embodiments of the invention and are therefore not limiting. The figures show:

FIG. 1 an exploded view of the battery;

FIG. 2 a front sectional view of the battery;

FIG. 3 a cooling system according to the invention and a multicopter; and

FIG. 4 a schematic representation of a holder for the battery.

### DETAILED DESCRIPTION

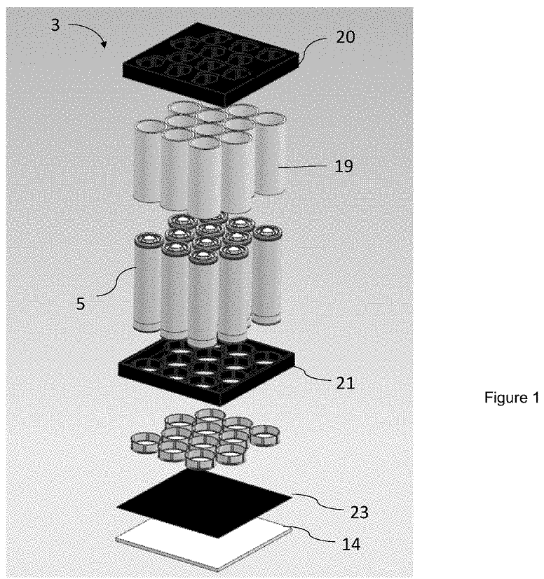

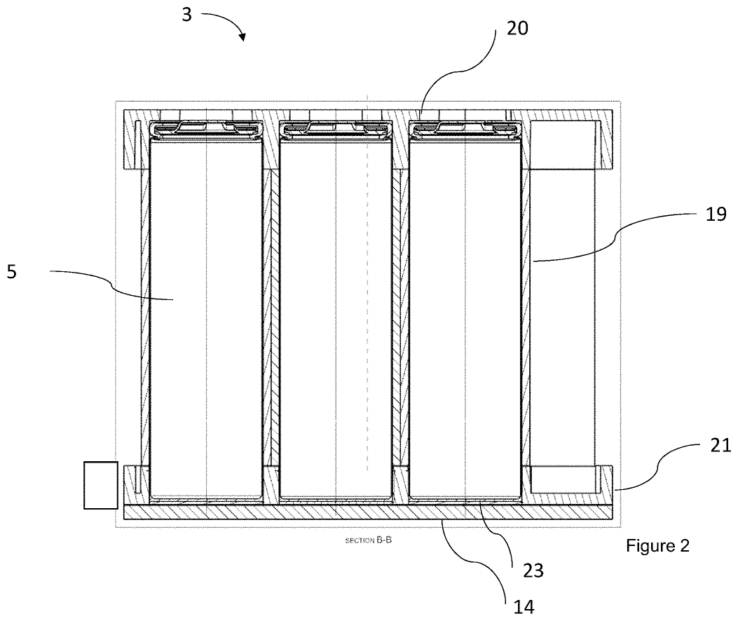

FIG. 1 shows an exploded view of the battery 3, which is shown in a sectional view in FIG. 2.

The battery cells 5 of the battery 3 are embodied as lithium-ion round cells and are arranged geometrically symmetrically.

The battery cells 5 are enclosed on the outer surfaces by sleeves 19. In the present case, the sleeves 19 are made of the phase change material of the latent heat store and a fire protection material. This creates direct thermal contact between the battery cells 5 and the latent heat stores 19.

The latent heat store is made in the present case of a composite material in which the phase change material is macroencapsulated in a carrier matrix. For example, materials such as paraffin compounds or ester compounds can be used as phase change material.

The fire protection material has a two-layer structure in which a first layer of the fire protection material in the form of a glass fiber layer is mechanically stable. The second layer of the fire protection material is made of hydrated minerals, in the present case water of crystallization.

The mechanically stable layer of the fire protection material prevents the battery cell from bursting open sideways in the event of overpressure during a thermal runaway of one of the battery cells. The second layer of the fire protection material, consisting of water of crystallization, serves to absorb heat released during the thermal runaway by the water contained in the layer being evaporated. During the phase transition of the water of crystallization, the temperature of the material can be kept constant so that adjacent battery cells are protected from overheating.

A first cell holder 20 and a second cell holder 21 are arranged above and below the battery cells. The cell holders 20, 21 serve to spatially fix the battery cells 5 in the housing of the battery 3 so that any forces acting on the battery cells 5 do not have to be supported by the sleeves 19.

A housing (not shown) is provided around the described components.

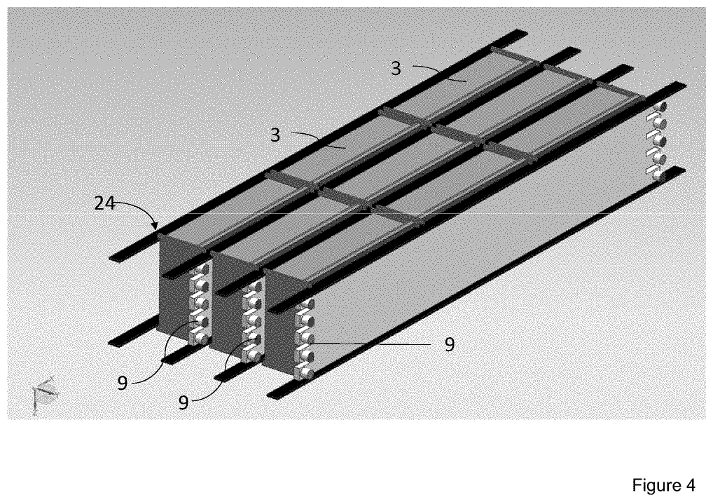

An electrically insulating layer 23 is provided to prevent the battery cells 5 from short-circuiting. A base plate 14 is arranged on the electrically insulating layer 23 as part of the battery housing. This layer is in contact with the cooling hose 9 in the second cooling device, see FIG. 4. Via the base plate 14 and the electrically insulating layer 23, the battery cells 5 and the material of the latent heat store 19 in contact with the battery cells can be brought into thermal contact with the second external cooling device. The base plate 14 and the electrically insulating layer 23 thus represent the thermal interface between the battery cooling device and the second separate cooling device.

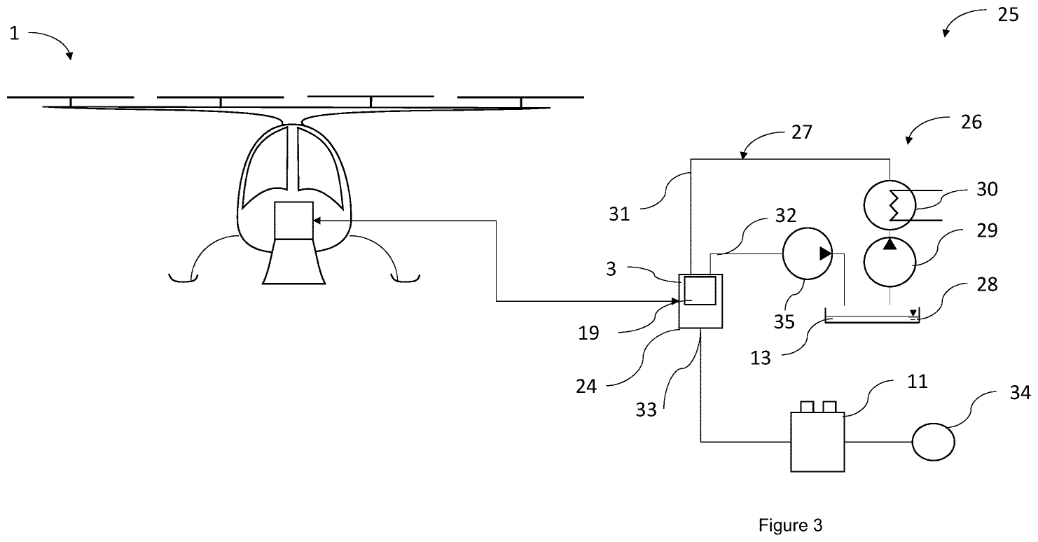

FIG. 3 shows a cooling system with a ground charging station 25 and a multicopter 1. The cooling system extends to the battery cooling device, which is typically on board the multicopter 1 when in operation, and to the second separate external cooling device 26 in the ground charging station 25.

During flight operation, the battery 3 is discharged and heat is transferred to the latent heat store 19. When the aircraft is stopped, the battery 3 is removed from the aircraft 1 and inserted into the holder 24 of the ground charging station 25.

The charging process of the battery is used to return the “spent” latent heat store unit 19 to its initial state, i.e. to return the liquid/viscous phase change material of the latent heat store 19 to a solid aggregate state. For this purpose, the battery 3 is removed from the aircraft and contacted both electrically and thermally in the ground charging station 25.

For this purpose, the ground charging station 25 comprises the second cooling device 26. The second cooling device 26 has a cooling circuit 27 with a coolant tank 28 and the coolant 13 contained therein. A pump 29 delivers the coolant 13 through a heat exchanger 30 and via the inlet 31 into the flexible cooling hose (not shown). The cooling hose runs in a holder 24 (see FIG. 4) into which the batteries 3 are inserted from the aircraft. The heated coolant 13 re-enters the coolant tank 28 through an outlet 32.

To improve the cooling effect of the flexible cooling hose, it can be subjected to a high internal pressure. This causes the cooling hose to expand and exerts a correspondingly high contact pressure on the components to be cooled, in particular the thermal interface in the form of the base plate 14 of the battery 3.

The cooling hose is filled with the coolant only after the battery 3 has been inserted into the holder 24.

At the same time, the battery cells of the battery 3 are electrically contacted with a stationary energy storage unit 11 via the connection 33 and are charged. The energy storage unit 11 is connected to a generator 34, by which it can be charged after or during the charging process.

In accordance with the invention, the cooling system shown reverses a phase transition of a heated latent heat store by means of active cooling. In this process, the liquid/viscous latent heat stores (19) are returned to a solid aggregate state.

Once the charging process has been completed and the latent heat store has been successfully restored to functionality, the battery 3 can be removed from the ground charging station 25 and is ready for use again.

FIG. 4 shows a holder 24 for the battery 3, as usually provided in a ground charging station 25 (FIG. 3). The holder 24 comprises a plurality of holding rails into which a plurality of batteries 3 can be inserted. Between the batteries there are provided cooling hoses 9, through which coolant can flow. The cooling hoses 9 are in thermal contact with the base plates 14 of the batteries 3 in the holding rails

1. A method for cooling a battery (3) for an electrically powered aircraft (1), the battery (3) comprising a battery cell (5) and a battery cooling device with at least one latent heat store (19), the method comprising the following steps:
A) transferring a first amount of heat from the battery cell (5) to the latent heat store (19), causing a phase transition to occur in the phase change material of the latent heat store (19),
B) removing the battery (3) from the aircraft (1),
C) establishing an operative connection of the battery cooling device to a cooling circuit (27) of a separate second cooling device (26),
D) passing a flow of a coolant (13) through the cooling circuit (27),
E) transferring a second amount of heat from the latent heat store (19) to the coolant (13), causing a phase transition to occur in the phase change material of the latent heat store (19), and
F) disconnecting the battery cooling device from the cooling circuit (27),
wherein at least one of step D or step E take place at least partially simultaneously with a charging process of the battery (3).

2. The method as claimed in claim 1, wherein step E takes place after step D, and the operative connection of the battery cooling device to the cooling circuit (27) is improved by an inflow of the coolant in method step E.

3. The method as claimed in claim 1, wherein the cooling circuit (27) operates according to a counterflow principle.

4. The method as claimed in claim 1, wherein after the step C, the method further comprises inserting the battery (3) into a holder of a ground charging station (25) which allows simultaneous charging of the battery (3) and cooling of the latent heat store (19).

5. A cooling system (6) for cooling a battery cell (5) of an electrically powered aircraft (1), the cooling system (6) comprising:
a battery cooling device configured to absorb a first amount of heat at least from the battery cell (5) during an electrical discharge process, the battery cooling device comprising at least one latent heat store (19) having a variable aggregate state;
a separate second cooling device (26) which is thermally coupleable to the battery cooling device and is configured to receive a second amount of heat from the battery cooling device; and
an electrical charging device for the battery cell (5) for electrically contacting and charging the battery cells (5) for the charging process of the battery cells (5).

6. The cooling system (6) as claimed in claim 5, wherein the phase change material of the latent heat store (19) of the battery cooling device is macroencapsulated in a carrier matrix.

7. The cooling system (6) as claimed in claim 5, wherein the phase change material of the latent heat store (19) of the battery cooling device comprises at least one of a sleeve around the battery cells, a plate of an at least partial housing around a plurality of battery cells, or at least one perforated plate.

8. The cooling system (6) as claimed in claim 5, wherein the phase change material of the latent heat store (19) is configure for a temperature range for heat generation of the battery cell (5) in an operating state in a range of 20° C. to 60° C.

9. The cooling system (6) as claimed in claim 5, further comprising a fire protection material located around the battery cells.

10. The cooling system (6) as claimed in claim 5, wherein the second cooling device (26) has at least one of a flexible hose (9) or a cooling plate which is finable with and passed through by a coolant (13).

11. The cooling system (6) as claimed in claim 5, wherein the second cooling device (26) is part of a stationary ground charging station (25) and the ground charging station (25) comprises an electrical charging device for the battery cell (5) and is configured to electrically contact the battery cells (5) for a charging process of the battery cell (5).

12. The cooling system (6) as claimed in claim 5, wherein the second cooling device (26) is part of a stationary ground charging station (25) and the ground charging station (25) comprises a holder for the battery (3) and is configured to connect the second cooling device (26) and the battery cooling device in a thermally conductive manner.

13. The cooling system (6) as claimed in claim 5, wherein the battery (3) comprises a busbar and the battery cell (5) is electrically conductively connected to the busbar.

14. The cooling system (6) as claimed in claim 13, wherein the battery cell (5) is electrically conductively connected to the busbar via at least one wire bond, the battery (3) comprises at least two battery cells (5) which are configured as cylindrical round cells (5) with a negatively polarized end face (N) and with a positively polarized end face (P), and the round cells (5) are geometrically oriented in a same way and are connected via the wire bond, on a same side of the battery cells.
